(19) United States
(12) Patent Application Publication
(10) Pub. No.: US 2026/0291848 A1
(43) Pub. Date: Sep. 24, 2026

(54) LOCAL PREFERENCE VALUE BASED ON CLUSTER SWITCHOVER QUANTITY

(71) Applicant: Juniper Networks, Inc., Sunnyvale, CA (US)

(72) Inventors: Cristina RADULESCU-BANU, Lexington, MA (US); John E. ZIEGLER, Westborough, MA (US); Steven P. ONISHI, Groton, MA (US); Allen WHITEHOUSE HORINE, Cary, NC (US)

(21) Appl. No.: 19/550,898

(22) Filed: Feb. 26, 2026

Related U.S. Application Data
(60) Provisional application No. 63/773,945, filed on Mar. 18, 2025.

(51) Int. Cl. H04L 45/02; H04L 45/00

(52) U.S. Cl. CPC H04L 45/04; H04L 45/22; H04L 45/54

(57) ABSTRACT

In some implementations, a system may identify that a cluster state associated with an application is active. The system may receive, in accordance with the cluster state being active, an indication of a quantity of multi-geographical cluster switchovers associated with the application. The system may configure, based on the quantity of multi-geographical cluster switchovers, a border gateway protocol advertisement indicating a local preference value associated with an external internet protocol address of the application.

### CROSS-REFERENCE TO RELATED APPLICATION

This Patent Application claims priority to U.S. Provisional Patent Application No. 63/773,945, filed on Mar. 18, 2025, and entitled “LOCAL PREFERENCE VALUE BASED ON CLUSTER SWITCHOVER QUANTITY.” The disclosure of the prior Application is considered part of and is incorporated by reference into this Patent Application.

### BACKGROUND

A cluster is a set of physical or virtual nodes (e.g., servers) that coordinate to perform one or more computational tasks. For example, a cluster may include one or more virtual machines or containers that are hosted on one or more physical servers. If a virtual machine or container running an application fails, then another virtual machine or container may start, thereby improving resiliency of the application.

### SUMMARY

Some implementations described herein relate to a method. The method may include identifying, by a system, that a cluster state associated with an application is active. The method may include receiving, by the system, in accordance with the cluster state being active, an indication of a quantity of multi-geographical cluster switchovers associated with the application. The method may include configuring, by the system, based on the quantity of multi-geographical cluster switchovers, a border gateway protocol (BGP) advertisement indicating a local preference value associated with an external internet protocol (IP) address of the application.

Some implementations described herein relate to a system. The system may include one or more memories and one or more processors. The one or more processors may be configured to identify that a cluster state associated with an application is active. The one or more processors may be configured to receive, in accordance with the cluster state being active, an indication of a quantity of multi-geographical cluster switchovers associated with the application. The one or more processors may be configured to configure, based on the quantity of multi-geographical cluster switchovers, a BGP advertisement indicating a local preference value associated with an external IP address of the application, wherein the local preference value is equal to a sum of the quantity of multi-geographical cluster switchovers and a default local preference value.

Some implementations described herein relate to a non-transitory computer-readable medium that stores a set of instructions. The set of instructions, when executed by one or more processors of a system, may cause the system to identify that a cluster state associated with an application is active. The set of instructions, when executed by one or more processors of the system, may cause the system to receive, in accordance with the cluster state being active, an indication of a quantity of multi-geographical cluster switchovers associated with the application. The set of instructions, when executed by one or more processors of the system, may cause the system to configure, based on the quantity of multi-geographical cluster switchovers, a BGP advertisement indicating a local preference value associated with an external IP address of the application. The set of instructions, when executed by one or more processors of the system, may cause the system to communicate with a device in accordance with the local preference value.

### BRIEF DESCRIPTION OF THE DRAWINGS

FIG. 1 is a diagram of an example implementation associated with cluster switchover using a local preference value.

FIG. 2 is a diagram of an example environment in which systems and/or methods described herein may be implemented.

FIG. 3 is a diagram of example components of a device associated with cluster switchover using a local preference value.

FIG. 4 is a flowchart of an example process associated with cluster switchover using a local preference value.

### DETAILED DESCRIPTION

The following detailed description of example implementations refers to the accompanying drawings. The same reference numbers in different drawings may identify the same or similar elements.

In a multi-geography, multi-cluster system, multiple clusters may coordinate across multiple geographical locations. For example, clusters (e.g., workload clusters) may be hosted in respective data centers in different geographical locations. Each cluster may use a range of external internet protocol (IP) addresses for applications (e.g., services) that corresponds to a geographical location of the cluster (e.g., the data center hosting the cluster). For example, each geographical location may be associated with an external IP address space that includes a set of external IP addresses, and a cluster within the geographical location may assign an external IP address to an application running on the cluster. An IP address of an application may be “external” in that devices or systems outside of the multi-geography, multi-cluster system may use the external IP address to access (e.g., interact with) an application. The devices or systems may include back-office systems, application devices, user plane devices, broadband network gateways (BNGs), remote authentication dial-in user service (RADIUS) servers, or the like.

In some examples, a first cluster in the multi-geography, multi-cluster system running an application may fail, prompting a switchover event (e.g., a failover event). The switchover event may involve a switch from the first cluster in a first data center to a second cluster in a second data center. Because external IP addresses can be assigned based on geographical location, the switchover event from the first data center (e.g., in a first geographical location) to the second data center (e.g., in a second geographical location) can cause the external IP address of the application to change. For example, the application may be assigned a first external IP address when running on the first cluster, and a second external IP address when running on the second cluster.

This change in external IP addresses (which may also be referred to as an “external IP address duality”) can cause complications for the devices or systems outside of the multi-geography, multi-cluster system that attempt to access the application. For example, the switchover event may disrupt a connection with a RADIUS server, which may be configured to maintain communication with the same IP address before and after switchover. Moreover, burdening the various devices or systems outside of the multi-geography, multi-cluster system that may attempt to interact with the application with handling changes in external IP addresses can increase consumption of processing and/or memory resources of those devices or systems.

Some implementations described herein enable an application to retain the same external IP address before and after a switchover event in a multi-geography, multi-cluster system. For example, a router may route, to a cluster, network traffic having a destination IP address set to the external IP address using a BGP local preference value. A path associated with a highest BGP local preference value may be a preferred path for the network traffic. For example, before the switchover event, a path to a first cluster may have a BGP local preference value of 100. After the switchover event, the application may be running on a second cluster, and the BGP local preference value of a path to the second cluster may be 101. Accordingly, before the switchover event, the router may route network traffic to the first cluster because the highest BGP local preference value is 100, and after the switchover event, the router may route network traffic to the second cluster because the highest BGP local preference value is 101. Both before and after the switchover event, the application may have the same external IP address, and the network traffic may have a destination address set to the same external IP address before and after the switchover event. The BGP preference value, which determines to which cluster the network traffic is routed, may be generated based on the cluster on which the application is currently active. For example, the BGP preference value may be configured such that network traffic is routed to an active cluster. If the application switches to another cluster, then the BGP preference value may be updated such that network traffic is routed to the other cluster. In some examples, the BGP local preference value may be determined based on a quantity of previous switchover events of the application. For example, if the quantity of previous switchover events is one, then the BGP local preference value may be set to one more than a default BGP local preference value (e.g., the BGP local preference value may be 100, and the BGP local preference value may be set to 101). In some examples, the quantity of switchover events may be tracked by a management system (e.g., a management cluster). The management system may notify the second system of the quantity of switchover events, which may enable the second system to determine the BGP local preference value. In some examples, the second system may configure a BGP advertisement with the BGP local preference value, and the BGP advertisement may notify the router of the BGP local preference value.

As a result, applications that experience switchover events may maintain reachability via the same one or more external IP addresses in real-time. For example, an external IP address of an application may remain constant across multi-geographical switchover events. For example, the clusters may reliably map the same set of external IP addresses to the same set of applications by exploiting the BGP local preference value. Thus, external systems or devices may use the external IP address and the BGP local preference value to navigate to the correct cluster where the external IP address is active, thereby mitigating complications for the systems or devices. For example, the switchover event may enable a RADIUS server to maintain communication with the application using the same external IP address before and after switchover. Moreover, using the BGP local preference value may help to reduce processing and/or memory resource consumption at the various devices or systems outside of the multi-geography, multi-cluster system that would otherwise attempt to interact with the application having changing external IP addresses.

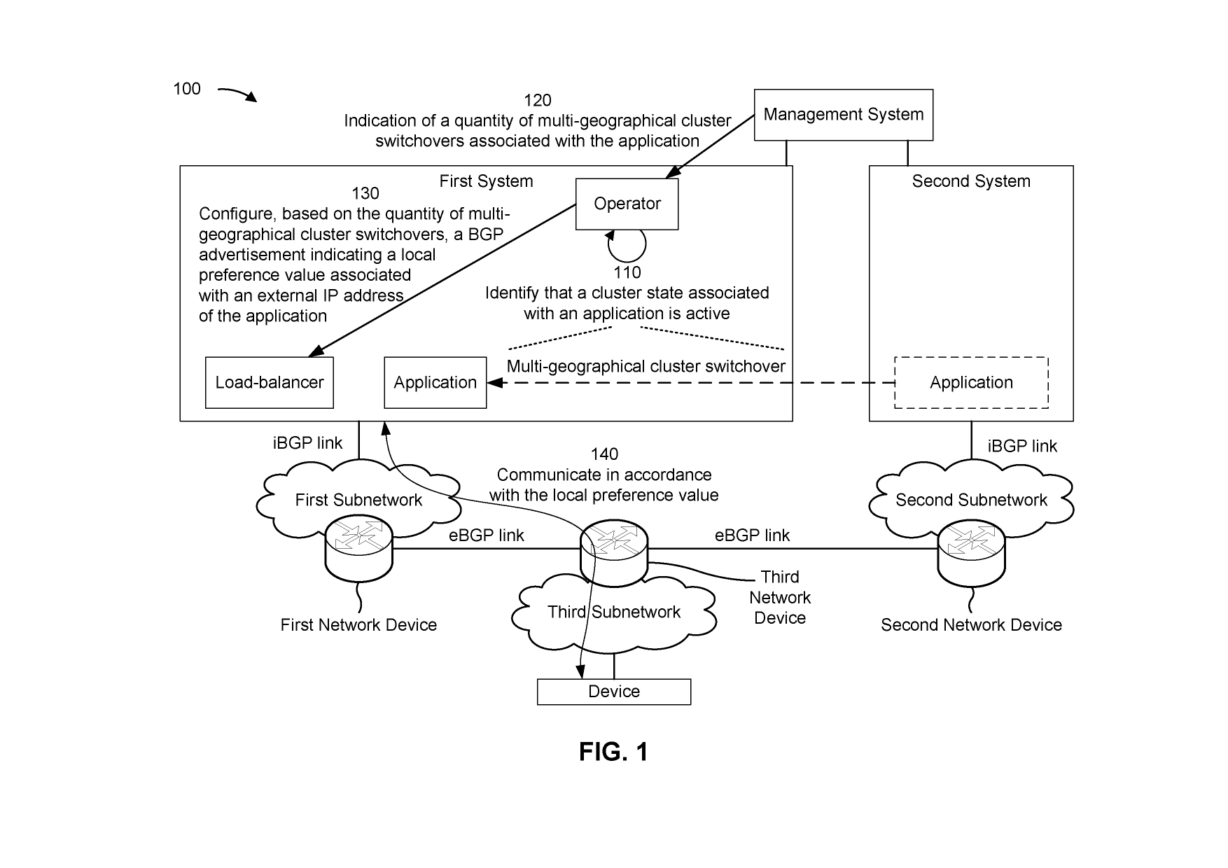

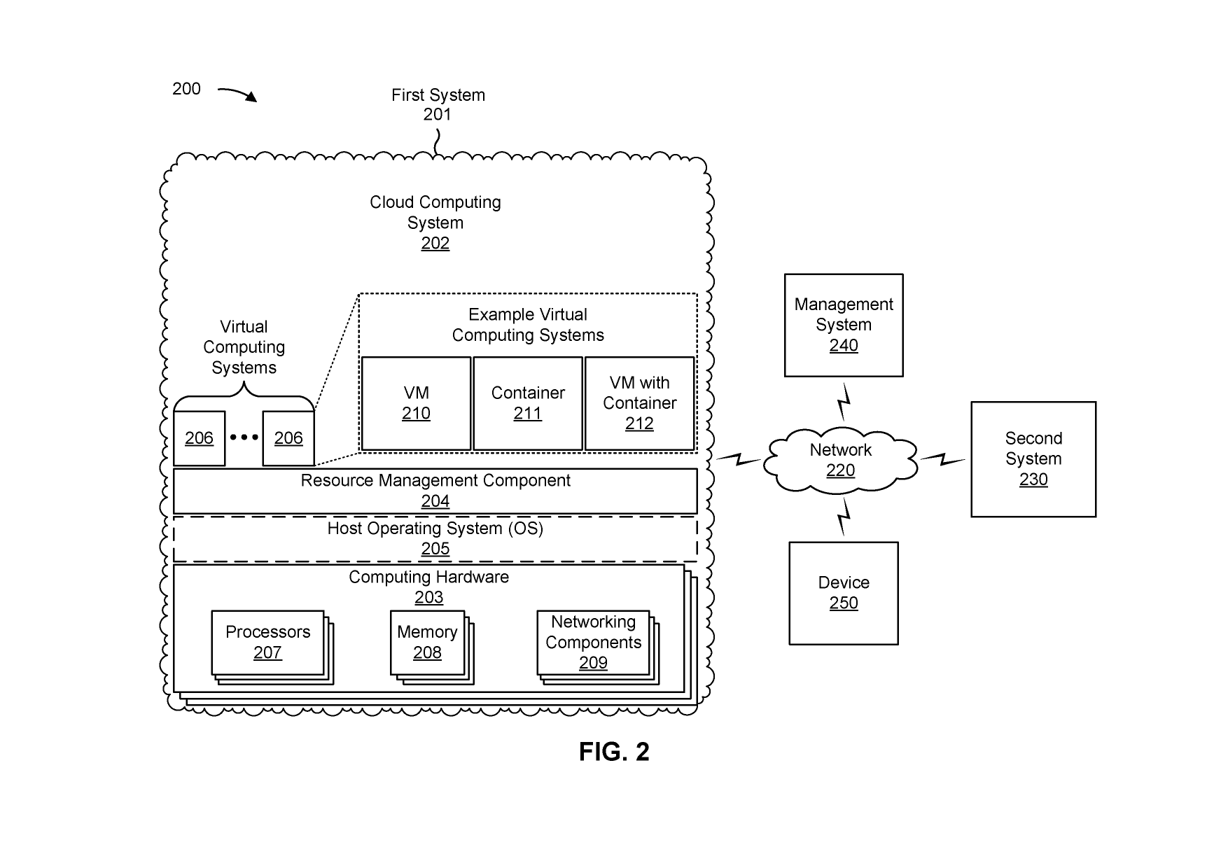

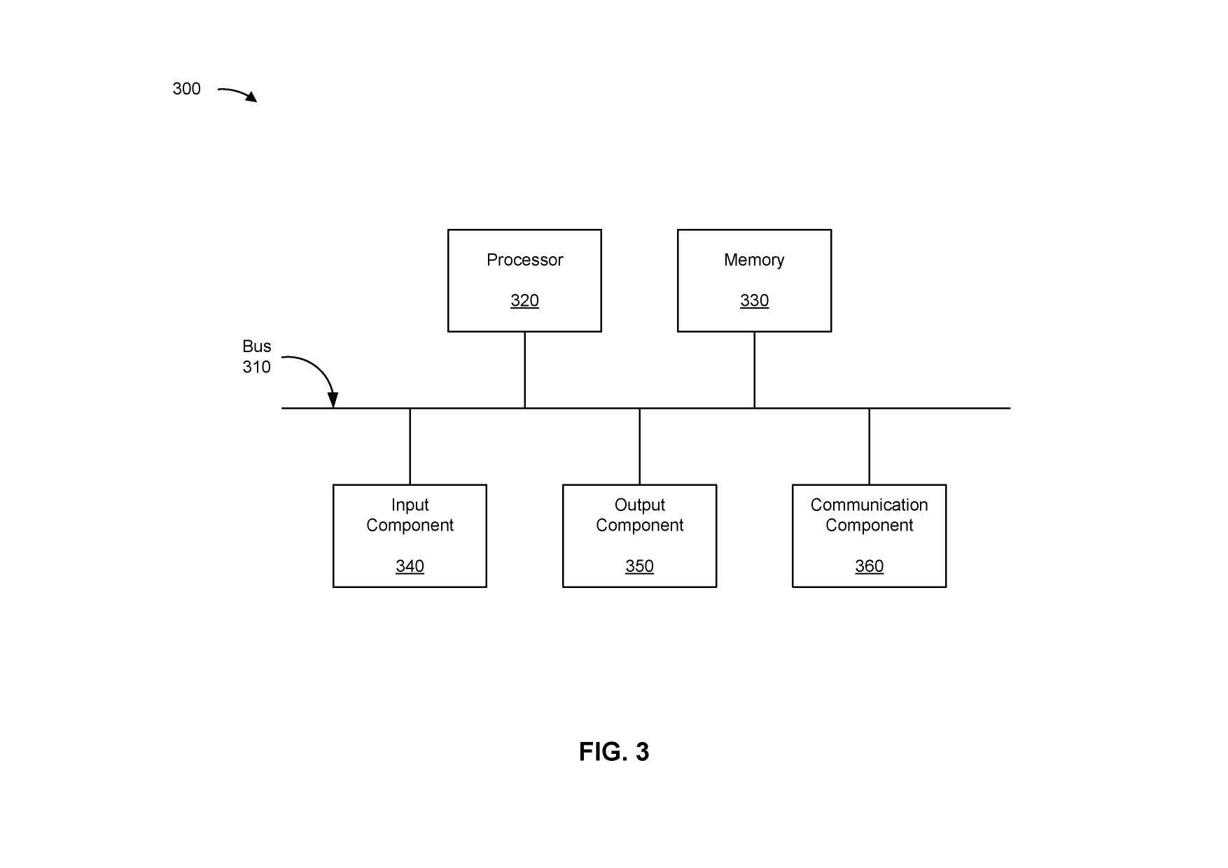

FIG. 1 is a diagram of an example implementation 100 associated with cluster switchover using a local preference value. As shown in FIG. 1, example implementation 100 includes a first system, a second system, a management system, and various devices. These systems and devices are described in more detail below in connection with FIGS. 2 and 3.

The first system and the second system may be respective sets of servers. For example, the first system may include a first set of servers in a first data center in a first geographical location, and the second system may include a second set of servers in a second data center in a second geographical location. For example, the first system and the second system may belong to a multi-geography, multi-cluster system, where the first system runs a first cluster, and the second system runs a second cluster. In some examples, the first system and the second system may belong to different autonomous systems (ASs), and may communicate with each other via an IP security (IPSec) tunnel. The first system may be configured to communicate with a first network device (e.g., a BGP-capable routing device) in a first subnetwork over an internal BGP (iBGP) link, and the second system may be configured to communicate with a second network device (e.g., a BGP-capable routing device) in a second subnetwork over another iBGP link. iBGP may be used for intra-network communications. For example, the first set of servers in the first system and the first network device may belong to the same (first) subnetwork, and the second set of servers in the second system and the second network device may belong to the same (second) subnetwork. The first and second network devices may be configured to communicate with a third network device (e.g., a BGP-capable routing device) in a third subnetwork over respective external BGP (eBGP) links. eBGP may be used for inter-network communications (e.g., the first network device, the second network device, and the third network device may belong to different subnetworks and/or ASs). The third network device may provide access to the first subnetwork or the second subnetwork on behalf of a device via the third subnetwork.

As shown by reference number 110, the first system may identify that a cluster state associated with an application is active. In some examples, the cluster state may be a state of the first cluster running in the first system. In some examples, an operator of the first system may identify that the cluster state is active. The operator may run within the cluster and handle functionality relating to aspects described herein, and may be referred to as a multi-geographic IP route prioritization (MIRP) operator. The cluster state may be associated with the application in that the cluster state may indicate the state of the cluster for that application. For example, the cluster state being active may indicate that the cluster is responsible for running the application. In other examples, the cluster state may be inactive, which may indicate that the cluster is acting as a backup cluster for an active cluster. For example, at a first time, the second system may have an active cluster state associated with the application (e.g., the second cluster may be an active cluster, and the first cluster may be a backup cluster). The second cluster may experience a partial or total failure that prompts a multi-geographical cluster switchover associated with the application. The multi-geographical cluster switchover may be a switchover of the application between clusters in respective geographical locations. For example, as shown, the application may switchover from the second system to the first system, which may cause the cluster state of the second system to switch to inactive, and the cluster state of the first system to switch to active. Thus, the operator may detect the application instance at the first system. In other examples, the first system may identify that the cluster state is active because a first instance of the application is established on the first system (e.g., the application may initially run on the first system).

As shown by reference number 120, the first system (e.g., the operator) may receive an indication of a quantity of multi-geographical cluster switchovers associated with the application. The quantity of multi-geographical cluster switchovers may be associated with the application in that the quantity of multi-geographical cluster switchovers may be a quantity of previous switchovers of the application between clusters in respective geographical locations (e.g., between virtual machines or containers that run different instances of the application). In some aspects, the multi-geographical cluster switchovers may be associated with a plurality of data centers. For example, the multi-geographical cluster switchovers may be switchovers of the application between clusters in respective data centers in the respective geographical locations. In some examples, the indication of the quantity of multi-geographical cluster switchovers may indicate a quantity that is equal to the quantity of multi-geographical cluster switchovers. In other examples, the indication of the quantity of multi-geographical cluster switchovers may be equal to a total quantity of generations of the application at a cluster (e.g., the indication of the quantity of multi-geographical cluster switchovers may indicate a quantity that is greater than or equal to the quantity of multi-geographical cluster switchovers). In some examples, the indication of the quantity of multi-geographical cluster switchovers may be referred to as a “generation number.” In some examples, the first system may receive the indication of the quantity of multi-geographical cluster switchovers in accordance with the cluster state being active. For example, the first system may receive the indication of the quantity of multi-geographical cluster switchovers before or after the cluster state becomes active.

In some aspects, the first system may receive (e.g., acquire) the indication of the quantity of multi-geographical cluster switchovers from the management system. The management system may include a set of servers in a data center that run a management cluster. The management system may be configured to track the quantity of multi-geographical cluster switchovers. For example, the management system may iterate the quantity of multi-geographical cluster switchovers each time that a multi-geographical cluster switchover of the application occurs. The management system may determine that a multi-geographical cluster switchover has occurred, such as based on an indication of the multi-geographical cluster switchover received from one or more of the first system or the second system, not receiving a message (e.g., a keepalive message) from the second system, or the like. In some examples, the management system may transmit the indication of the quantity of multi-geographical cluster switchovers to the first system in response to determining that a multi-geographical cluster switchover has occurred. Additionally, or alternatively, the first system may transmit a request for the indication of the quantity of multi-geographical cluster switchovers, and the management system may transmit the indication of the quantity of multi-geographical cluster switchovers in response to the request.

As shown by reference number 130, the first system (e.g., the operator) may configure, based on the quantity of multi-geographical cluster switchovers, a BGP advertisement indicating a local preference value associated with an external IP address of the application. The local preference value may be a value of a BGP local preference attribute that indicates a preferred path of multiple candidate paths. The local preference value may be associated with the external IP address (e.g., a service address) in that the local preference value may be a value of a BGP local preference attribute that indicates a preferred path for network traffic having a destination IP address set to the external IP address. For example, the preferred path for the network traffic may be the path having the highest local preference value of multiple candidate paths for the network traffic. The first system may configure the local preference value to be greater than any other local preference values associated with the external IP address. For example, the first system (e.g., the active cluster) may configure the local preference value to be greater than the local preference value for the second system (e.g., the backup cluster). Thus, the external IP address (and/or an external IP address space that includes the external IP address) may be valid in the first subnetwork and/or the second subnetwork, and the local preference value may cause network traffic having the destination IP address set to the external IP address to be routed to the first system, where the external IP address is currently active.

In some aspects, the local preference value may be equal to a sum of the quantity of multi-geographical cluster switchovers and a default local preference value. The default local preference value may be a lowest value for the local preference attribute and may correspond to a lowest priority for a path. In some examples, the local preference value may iterate with each multi-geographical cluster switchover. For example, if the default local preference value is 100, and the multi-geographical cluster switchover from the second system to the first system is the first multi-geographical cluster switchover of the application, then the first system may configure the BGP advertisement to indicate a local preference value of 101. Additionally, or alternatively, the local preference value may be equal to a sum of the total quantity of generations of the application and the default local preference value.

In some examples, the operator may interact with a load balancer, such as a network load-balancing instance running on the first cluster, to configure the BGP advertisement (e.g., a BGP advertisement update) with the local preference value. The load balancer may manage load-balancing of network traffic on behalf of the application using any suitable protocol or protocol family, such as transmission control protocol (TCP), user datagram protocol (UDP), or the like (e.g., the application may be exposed using TCP, UDP, or the like). For example, the operator may indicate the quantity of multi-geographical cluster switchovers to the load balancer, which may derive the local preference value. In some examples, the external IP address may be associated with the load balancer. In some examples, the load balancer may be configured in a Layer 3 (L3) mode. In some examples, the load balancer may be configured with a BGP peering session with one or more upstream routers (e.g., the first network device) serving the first subnetwork. For example, the first network device may be an iBGP peer of the load balancer (e.g., which may function as a router local to the first cluster). In some examples, the load balancer may transmit the BGP advertisement to the first network device, and the BGP advertisement (and, thus, the local preference value) may be propagated throughout a network, including to the third network device. Thus, in some examples, the operator may configure the load balancer (which has an iBGP peering relationship with the first network device) with the BGP advertisement and local preference value, and the load balancer may, based on the configured BGP advertisement and local preference value, advertise a route (e.g., with the local preference value) to the third network device.

As shown by reference number 140, the first system may communicate with the device in accordance with the local preference value. For example, the first system may transmit network traffic to, and/or receive network traffic from, the device based on the local preference value. For example, the device may transmit, to the third network device, network traffic that includes a destination IP address set to the external IP address. The third network device may determine that the highest local preference value of the external IP address is associated with a path to the application running on the first system. Accordingly, the third network device may route network traffic with the destination IP address set to the external IP address over the preferred path to the first system (e.g., instead of routing the network traffic over a less preferred path to the second system). Additionally, or alternatively, the first system may transmit the network traffic to the device after the BGP advertisement with the local preference value has propagated to the third network device. Thus, the device may use the same external IP address to communicate with the application before and after a multi-geographical cluster switchover. For example, the application may define load-balancing services such that external IP address assignment is consistent across application deployments in respective clusters.

In some aspects, the application may be an address pool manager (APM). The APM may be an application (e.g., a container-based application) that manages IP addresses in a network. The APM may provision prefixes from an IP address pool to the device. In some aspects, the device may be a BNG. For example, the APM may provision the BNG with IP addresses for utilization by customer premises equipment (CPE) in communication with the BNG. For example, the same external IP address may be used for the APM on each cluster (e.g., on the first cluster and the second cluster). The operator may configure BGP advertisements with a local preference value for the external IP address of the APM, which may cause BNG traffic to be routed to the active APM (e.g., the APM running on the first cluster). In some aspects, the device may be RADIUS server. For example, the RADIUS server may provide centralized authentication, authorization, and accounting management for the application. For example, a user may transmit a request to access the application to a network access server, and the network access server may transmit an access request to the RADIUS server. The RADIUS server may analyze information in the access request (e.g., user information, access information, or the like) and transmit, to the network access server, an access accept message, an access reject message, or an access challenge message. In some examples, the access accept message may include an IP address assigned to a user or an IP address pool from which an IP address may be assigned to the user. For example, the IP address pool may be indicated by the APM.

Configuring the BGP advertisement indicating the local preference value based on the quantity of multi-geographical cluster switchovers may help to enable an application that experiences a multi-geographical cluster switchover to maintain reachability via the same external IP address in real-time. For example, the external IP address of the application may remain constant before and after the multi-geographical cluster switchover. As a result, the device may use the external IP address and the BGP local preference value to navigate to the correct cluster where the external IP address is active, thereby mitigating complications for the device. For example, the device may maintain connectivity with the application using the same external IP address before and after the multi-geographical cluster switchover. Therefore, the local preference value may help the device to reduce consumption of processing and/or memory resources that would otherwise be allocated for interaction with the application based on changing external IP addresses.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example environment 200 in which systems and/or methods described herein may be implemented. As shown in FIG. 2, environment 200 may include a first system 201, which may include one or more elements of and/or may execute within a cloud computing system 202. The cloud computing system 202 may include one or more elements 203-212, as described in more detail below. As further shown in FIG. 2, environment 200 may include a network 220, a second system 230, a management system 240, and/or a device 250. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

In some aspects, the first system 201 may host one or more clusters. Although the first system 201 may include one or more elements 203-212 of the cloud computing system 202, may execute within the cloud computing system 202, and/or may be hosted within the cloud computing system 202, in some implementations, the first system 201 may not be cloud-based (e.g., may be implemented outside of a cloud computing system) or may be partially cloud-based. For example, the first system 201 may include one or more devices that are not part of the cloud computing system 202, such as device 300 of FIG. 3, which may include a standalone server or another type of computing device. The first system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some examples, the network 220 may include one or more subnetwork and/or network devices, such as those shown in FIG. 1.

The second system 230 may include a cloud computing system similar to the cloud computing system 202. For example, the second system 230 may include one or more elements similar to elements 203-212 of the cloud computing system 202. In some aspects, the second system 230 may host one or more clusters. In some implementations, the second system 230 may not be cloud-based (e.g., may be implemented outside of a cloud computing system) or may be partially cloud-based. For example, the second system 230 may include one or more devices that are not part of the cloud computing system, which may include a standalone server or another type of computing device.

The management system 240 may include a cloud computing system similar to the cloud computing system 202. For example, the management system 240 may include one or more elements similar to elements 203-212 of the cloud computing system 202. In some aspects, the management system 240 may host one or more clusters. In some implementations, the management system 240 may not be cloud-based (e.g., may be implemented outside of a cloud computing system) or may be partially cloud-based. For example, the management system 240 may include one or more devices that are not part of the cloud computing system, which may include a standalone server or another type of computing device.

The device 250 may include one or more devices capable of receiving, processing, storing, routing, and/or providing traffic (e.g., a packet and/or other information or metadata) in a manner described herein. For example, the device 250 may include a RADIUS server, a BNG, an application device (e.g., a user device), a device in a back-office system, or the like.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with cluster switchover using a local preference value. The device 300 corresponds to one or more of the first system 201, the second system 230, the management system 240, and/or the device 250. In some implementations, the first system 201, the second system 230, the management system 240, and/or the device 250 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

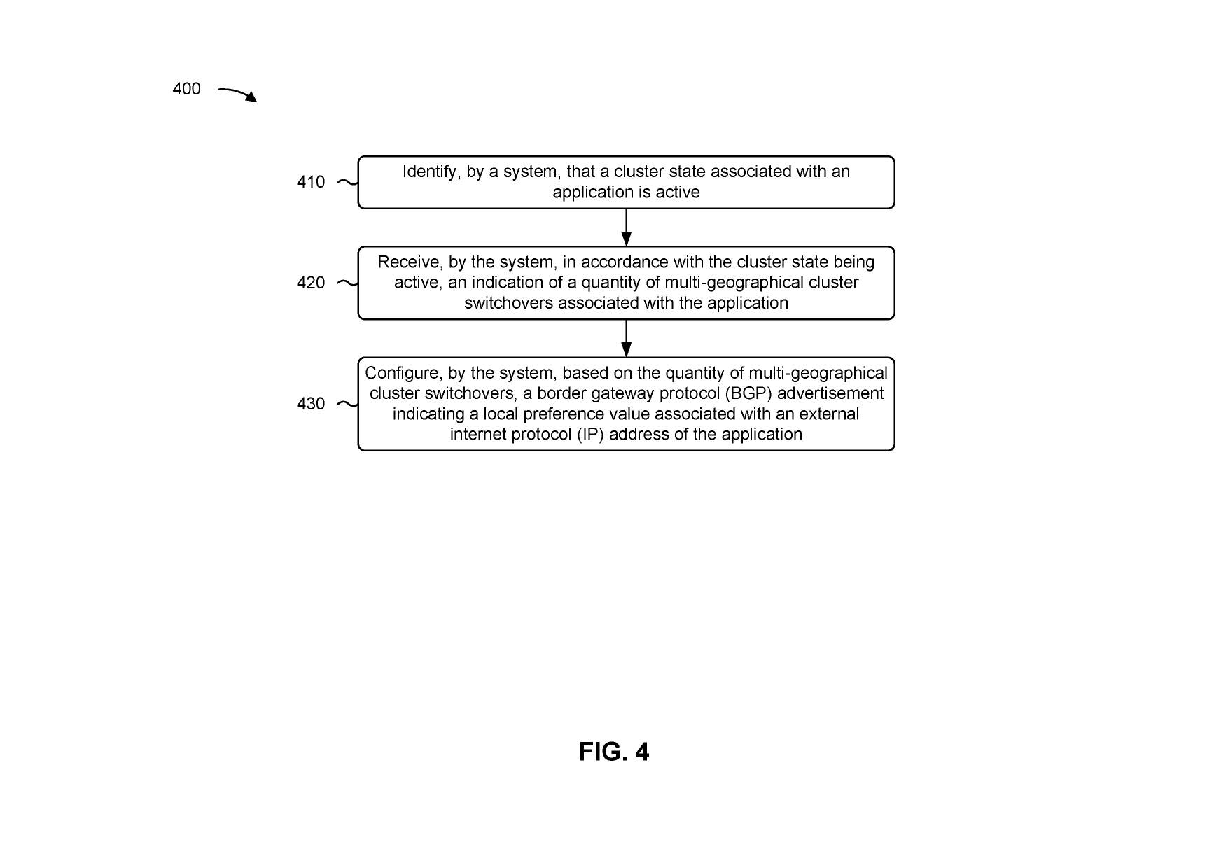

FIG. 4 is a flowchart of an example process 400 associated with cluster switchover using a local preference value. One or more process blocks of FIG. 4 are performed by a system (e.g., the first system 201) and/or by another device or a group of devices separate from or including the system, such as a second system (e.g., the second system 230), a management system (e.g., the management system 240, and/or a device (e.g., the device 250). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes identifying that a cluster state associated with an application is active (block 410). For example, the system may identify that a cluster state associated with an application is active, as described above.

As further shown in FIG. 4, process 400 includes receiving in accordance with the cluster state being active, an indication of a quantity of multi-geographical cluster switchovers associated with the application (block 420). For example, the system may receive, in accordance with the cluster state being active, an indication of a quantity of multi-geographical cluster switchovers associated with the application, as described above.

As further shown in FIG. 4, process 400 includes configuring based on the quantity of multi-geographical cluster switchovers, a BGP advertisement indicating a local preference value associated with an external IP address of the application (block 430). For example, the system may configure, based on the quantity of multi-geographical cluster switchovers, a BGP advertisement indicating a local preference value associated with an external IP address of the application, as described above.

Process 400 may include additional aspects, such as any single aspect or any combination of aspects described below and/or in connection with one or more other processes described elsewhere herein.

In a first aspect, the multi-geographical cluster switchovers are associated with a plurality of data centers.

In a second aspect, alone or in combination with the first aspect, the local preference value is equal to a sum of the quantity of multi-geographical cluster switchovers and a default local preference value.

In a third aspect, alone or in combination with one or more of the first and second aspects, the application is an address pool manager.

In a fourth aspect, alone or in combination with one or more of the first through third aspects, process 400 includes communicating with a device in accordance with the local preference value.

In a fifth aspect, alone or in combination with one or more of the first through fourth aspects, the device is a broadband network gateway.

In a sixth aspect, alone or in combination with one or more of the first through fifth aspects, the device is a RADIUS server.

In a seventh aspect, alone or in combination with one or more of the first through sixth aspects, receiving the indication of the quantity of multi-geographical cluster switchovers includes receiving the indication of the quantity of multi-geographical cluster switchovers from a management system.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
identifying, by a system, that a cluster state associated with an application is active;
receiving, by the system, in accordance with the cluster state being active, an indication of a quantity of multi-geographical cluster switchovers associated with the application; and
configuring, by the system, based on the quantity of multi-geographical cluster switchovers, a border gateway protocol (BGP) advertisement indicating a local preference value associated with an external internet protocol (IP) address of the application.

2. The method of claim 1, wherein the multi-geographical cluster switchovers are associated with a plurality of data centers.

3. The method of claim 1, wherein the local preference value is equal to a sum of the quantity of multi-geographical cluster switchovers and a default local preference value.

4. The method of claim 1, wherein the application is an address pool manager.

5. The method of claim 1, further comprising:
communicating with a device in accordance with the local preference value.

6. The method of claim 5, wherein the device is a broadband network gateway.

7. The method of claim 5, wherein the device is a remote authentication dial-in user service (RADIUS) server.

8. The method of claim 1, wherein receiving the indication of the quantity of multi-geographical cluster switchovers includes receiving the indication of the quantity of multi-geographical cluster switchovers from a management system.

9. A system, comprising:
one or more memories; and
one or more processors to:
identify that a cluster state associated with an application is active;
receive, in accordance with the cluster state being active, an indication of a quantity of multi-geographical cluster switchovers associated with the application; and
configure, based on the quantity of multi-geographical cluster switchovers, a border gateway protocol (BGP) advertisement indicating a local preference value associated with an external internet protocol (IP) address of the application, wherein the local preference value is equal to a sum of the quantity of multi-geographical cluster switchovers and a default local preference value.

10. The system of claim 9, wherein the multi-geographical cluster switchovers are associated with a plurality of data centers.

11. The system of claim 9, wherein the application is an address pool manager.

12. The system of claim 9, wherein the one or more processors are further to:
communicate with a device in accordance with the local preference value.

13. The system of claim 12, wherein the device is a broadband network gateway.

14. The system of claim 12, wherein the device is a remote authentication dial-in user service (RADIUS) server.

15. The system of claim 9, wherein the one or more processors, to receive the indication of the quantity of multi-geographical cluster switchovers, are to receive the indication of the quantity of multi-geographical cluster switchovers from a management system.

16. A non-transitory computer-readable medium storing a set of instructions, the set of instructions comprising:
one or more instructions that, when executed by one or more processors of a system, cause the system to:
identify that a cluster state associated with an application is active;
receive, in accordance with the cluster state being active, an indication of a quantity of multi-geographical cluster switchovers associated with the application;
configure, based on the quantity of multi-geographical cluster switchovers, a border gateway protocol (BGP) advertisement indicating a local preference value associated with an external internet protocol (IP) address of the application; and
communicate with a device in accordance with the local preference value.

17. The non-transitory computer-readable medium of claim 16, wherein the multi-geographical cluster switchovers are associated with a plurality of data centers.

18. The non-transitory computer-readable medium of claim 16, wherein the local preference value is equal to a sum of the quantity of multi-geographical cluster switchovers and a default local preference value.

19. The non-transitory computer-readable medium of claim 16, wherein the device is a broadband network gateway.

20. The non-transitory computer-readable medium of claim 16, wherein the device is a remote authentication dial-in user service (RADIUS) server.
